(19) United States
(12) Patent Application Publication
(10) Pub. No.: US 2022/0132579 A1
(43) Pub. Date: Apr. 28, 2022

(54) COMMUNICATIONS DEVICE, INFRASTRUCTURE EQUIPMENT AND METHODS

(71) Applicant: Sony Group Corporation, Tokyo (JP)

(72) Inventors: Yassin Aden AWAD, Basingstoke (GB); Vivek SHARMA, Basingstoke (GB); Anders BERGGREN, Lund (SE); Yuxin WEI, Basingstoke (GB); Hideji WAKABAYASHI, Basingstoke (GB)

(73) Assignee: Sony Group Corporation, Tokyo (JP)

(21) Appl. No.: 17/428,634

(22) PCT Filed: Jan. 17, 2020
(86) PCT No.: PCT/EP2020/051126

§ 371 Date: Aug. 5, 2021

(30) Foreign Application Priority Data
Feb. 14, 2019 (EP) 19157268.4

(51) Int. Cl. H04W 74/08; H04W 72/08; H04L 1/18

(52) U.S. Cl. CPC H04W 74/0833; H04L 1/1812; H04W 72/08

(57) ABSTRACT

A communications device comprising circuitry configured to transmit signals to infrastructure equipment via a wireless access interface provided by a wireless communications network, receive signals from the infrastructure equipment, receive an indication of one or more communications parameters from the infrastructure equipment, the indication of the one or more communications parameters comprising an indication of a plurality of reference signal received power, RSRP, thresholds, determine, based on the received indication of the one or more communications parameters, a location of the communications device with respect to a location of the infrastructure equipment, transmit a first signal comprising a random access preamble and uplink data to the infrastructure equipment, the uplink data being transmitted in a set of communications resources of the wireless access interface, the random access preamble being associated with the set of communications resources, and receive a random access response from the infrastructure equipment.

### BACKGROUND

### Field of Disclosure

The present disclosure relates to communications devices which are configured to transmit data to and receive data from infrastructure equipment of a wireless communications network, in accordance with an enhanced random access (RACH) procedure.

The present application claims the Paris Convention priority of European patent application no. EP19157268, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will be expected to routinely and efficiently support communications with a wider range of devices associated with a wider range of data traffic profiles and types than current systems are optimised to support. For example it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems, as well as future iterations/releases of existing systems, to efficiently support connectivity for a wide range of devices associated with different applications and different characteristic data traffic profiles.

One example area of current interest in this regard includes the so-called “The Internet of Things” or IoT for short. The 3GPP has proposed in Release 13 of the 3GPP specifications to develop technologies for supporting narrowband (NB)-IoT and so-called enhanced MTC (eMTC) operation using a LTE/4G wireless access interface and wireless infrastructure. More recently there have been proposals to build on these ideas in Release 14 of the 3GPP specifications with so-called enhanced NB-IoT (eNB-IoT) and further enhanced MTC (feMTC), and in Release 15 of the 3GPP specifications with so-called further enhanced NB-IoT (feNB-IoT) and even further enhanced MTC (efeMTC). See, for example, [1], [2], [3], [4]. At least some devices making use of these technologies are expected to be low complexity and inexpensive devices requiring relatively infrequent communication of relatively low bandwidth data.

The increasing use of different types of network infrastructure equipment and terminal devices associated with different traffic profiles give rise to new challenges for efficiently handling communications in wireless communications systems that need to be addressed.

### SUMMARY OF THE DISCLOSURE

The present disclosure can help address or mitigate at least some of the issues discussed above.

As such, embodiments of the present technique can provide a communications device for transmitting data to an infrastructure equipment of a wireless communications network. The infrastructure equipment provides a cell having a coverage area in which the communications device is located. The communications device comprises transmitter circuitry configured to transmit signals to the infrastructure equipment via a wireless access interface provided by the wireless communications network, receiver circuitry configured to receive signals from the infrastructure equipment via the wireless access interface, and controller circuitry configured in combination with the receiver circuitry and the transmitter circuitry to receive an indication of one or more communications parameters from the infrastructure equipment, the indication of the one or more communications parameters comprising an indication of a plurality of reference signal received power, RSRP, thresholds, to determine, based on the received indication of the one or more communications parameters, a location of the communications device with respect to a location of the infrastructure equipment, to transmit a first signal comprising a random access preamble and uplink data to the infrastructure equipment, the uplink data being transmitted in a set of communications resources of the wireless access interface, the random access preamble being associated with the set of communications resources, and to receive a random access response from the infrastructure equipment. At least one of the random access preamble and a modulation and coding scheme, MCS, with which the first signal is transmitted indicate the location of the communications device with respect to the location of the infrastructure equipment.

Embodiments of the present technique, which further relate to an infrastructure equipment, methods of operating a communications device and infrastructure equipment, as well as circuitry for the same, can provide a hybrid, enhanced RACH procedure which can be used in NR wireless communications system where the resources required for the transmission of the first message in the presently known two-step RACH procedure may be optimised.

Respective aspects and features of the present disclosure are defined in the appended claims. It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic representation illustrating steps in a four-step random access procedure in a wireless telecommunications network;

FIG. 4 is a schematic representation illustrating an example of uplink data transmission of a communications device in RRC_INACTIVE mode with a downlink response from the network;

FIG. 5 is a schematic representation illustrating an example RACH procedure which could be applied for transmissions of small amounts of data;

FIG. 6 is a schematic representation illustrating an example two-step RACH procedure which could be applied for transmissions of small amounts of data;

FIG. 7 is a schematic representation illustrating steps in a two-step random access procedure in a wireless telecommunications network;

FIG. 8 is a part schematic representation, part message flow diagram of communications between a communications device and an infrastructure equipment of a wireless communications network in accordance with embodiments of the present technique;

FIG. 9 shows an example of how a cell may be divided into a plurality of regions based on reference signal received power (RSRP) thresholds in accordance with embodiments of the present technique;

FIG. 10A shows an example of how a UE transmission may be in accordance with different MCS levels in accordance with embodiments of the present technique;

FIG. 10B shows an example of how a UE transmission may be in accordance with different redundancy versions in accordance with embodiments of the present technique; and

FIG. 11 shows a flow diagram illustrating a process of communications between a communications device and an infrastructure equipment in accordance with embodiments of the present technique.

### DETAILED DESCRIPTION OF THE EMBODIMENTS

### Long Term Evolution Advanced Radio Access Technology (4G)

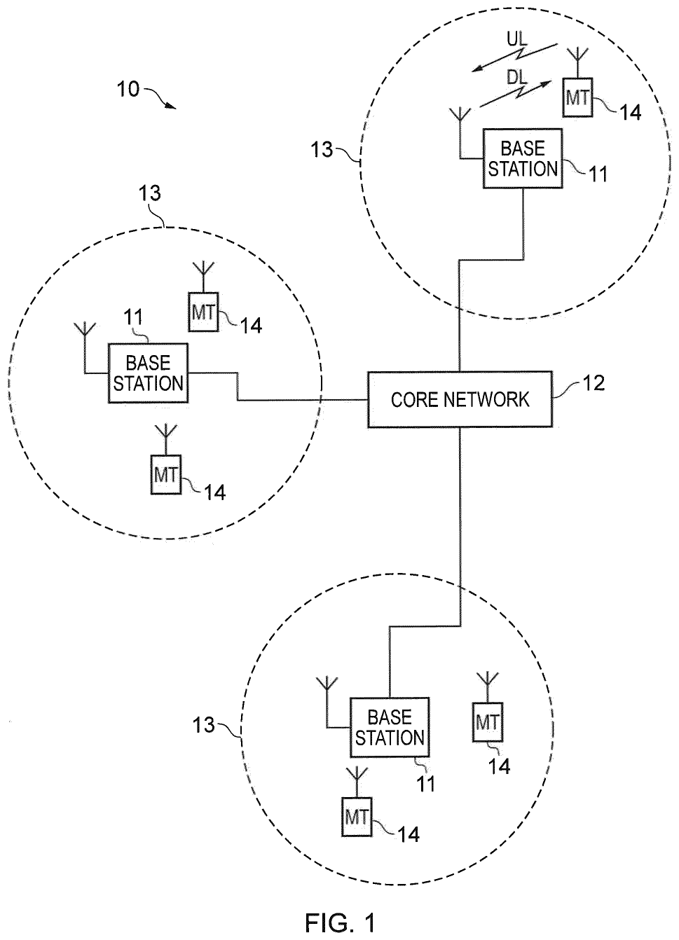

FIG. 1 provides a schematic diagram illustrating some basic functionality of a mobile telecommunications network/system 10 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [5]. It will be appreciated that operational aspects of the telecommunications (or simply, communications) networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 10 includes a plurality of base stations 11 connected to a core network 12. Each base station provides a coverage area 13 (i.e. a cell) within which data can be communicated to and from terminal devices 14. Data is transmitted from base stations 11 to terminal devices 14 within their respective coverage areas 13 via a radio downlink (DL). Data is transmitted from terminal devices 14 to the base stations 11 via a radio uplink (UL). The core network 12 routes data to and from the terminal devices 14 via the respective base stations 11 and provides functions such as authentication, mobility management, charging and so on. Terminal devices may also be referred to as mobile stations, user equipment (UE), user terminal, mobile radio, communications device, and so forth. Base stations, which are an example of network infrastructure equipment/network access node, may also be referred to as transceiver stations/nodeBs/e-nodeBs/eNBs/g-nodeBs/gNBs and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

As mentioned above, the embodiments of the present invention can find application with advanced wireless communications systems such as those referred to as 5G or New Radio (NR) Access Technology. The use cases that are considered for NR include:
Enhanced Mobile Broadband (eMBB)
Massive Machine Type Communications (mMTC)
Ultra Reliable & Low Latency Communications (URLLC) [6]
   eMBB services are characterised by high capacity with a requirement to support up to 20 Gb/s. The requirement for URLLC is a reliability of 1-10⁻⁵ (99.999%) for one transmission of a relatively short packet such as 32 bytes with a user plane latency of 1 ms.

The elements of the wireless access network shown in FIG. 1 may be equally applied to a 5G new RAT configuration, except that a change in terminology may be applied as mentioned above.

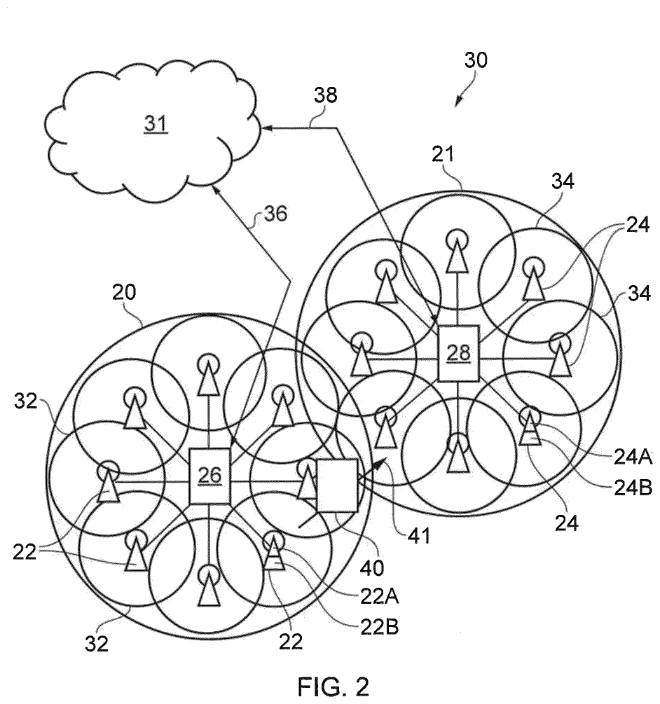

FIG. 2 is a schematic diagram illustrating a network architecture for a new RAT wireless mobile telecommunications network/system 30 based on previously proposed approaches which may also be adapted to provide functionality in accordance with embodiments of the disclosure described herein. The new RAT network 30 represented in FIG. 2 comprises a first communication cell 20 and a second communication cell 21. Each communication cell 20, 21, comprises a controlling node (centralised unit, CU) 26, 28 in communication with a core network component 31 over a respective wired or wireless link 36, 38. The respective controlling nodes 26, 28 are also each in communication with a plurality of distributed units (radio access nodes/remote transmission and reception points (TRPs)) 22, 24 in their respective cells. Again, these communications may be over respective wired or wireless links. The distributed units (DUs) 22, 24 are responsible for providing the radio access interface for terminal devices connected to the network. Each distributed unit 22, 24 has a coverage area (radio access footprint) 32, 34 which together define the coverage of the respective communication cells 20, 21. Each distributed unit 22, 24 includes transceiver circuitry 22a, 24a for transmission and reception of wireless signals and processor circuitry 22b, 24b configured to control the respective distributed units 22, 24.

In terms of broad top-level functionality, the core network component 31 of the new RAT telecommunications system represented in FIG. 2 may be broadly considered to correspond with the core network 12 represented in FIG. 1, and the respective controlling nodes 26, 28 and their associated distributed units/TRPs 22, 24 may be broadly considered to provide functionality corresponding to base stations of FIG. 1, and so these terms (as well as indeed eNodeB, gNodeB, etc.) are interchangeable. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the terminal devices may lie with the controlling node/centralised unit and/or the distributed units/TRPs.

A terminal device 40 is represented in FIG. 2 within the coverage area of the first communication cell 20. This terminal device 40 may thus exchange signalling with the first controlling node 26 in the first communication cell via one of the distributed units 22 associated with the first communication cell 20. In some cases communications for a given terminal device are routed through only one of the distributed units, but it will be appreciated in some other implementations communications associated with a given terminal device may be routed through more than one distributed unit, for example in a soft handover scenario and other scenarios.

The particular distributed unit(s) through which a terminal device is currently connected through to the associated controlling node may be referred to as active distributed units for the terminal device. Thus the active subset of distributed units for a terminal device may comprise one or more than one distributed unit (DU/TRP). The controlling node 26 is responsible for determining which of the distributed units 22 spanning the first communication cell 20 is responsible for radio communications with the terminal device 40 at any given time (i.e. which of the distributed units are currently active distributed units for the terminal device). Typically this will be based on measurements of radio channel conditions between the terminal device 40 and respective ones of the distributed units 22. In this regard, it will be appreciated the subset of the distributed units in a cell which are currently active for a terminal device will depend, at least in part, on the location of the terminal device within the cell (since this contributes significantly to the radio channel conditions that exist between the terminal device and respective ones of the distributed units).

In at least some implementations the involvement of the distributed units in routing communications from the terminal device to a controlling node (controlling unit) is transparent to the terminal device 40. That is to say, in some cases the terminal device may not be aware of which distributed unit is responsible for routing communications between the terminal device 40 and the controlling node 26 of the communication cell 20 in which the terminal device is currently operating, or even if any distributed units 22 are connected to the controlling node 26 and involved in the routing of communications at all. In such cases, as far as the terminal device is concerned, it simply transmits uplink data to the controlling node 26 and receives downlink data from the controlling node 26 and the terminal device has no awareness of the involvement of the distributed units 22, though may be aware of radio configurations transmitted by distributed units 22. However, in other embodiments, a terminal device may be aware of which distributed unit(s) are involved in its communications. Switching and scheduling of the one or more distributed units may be done at the network controlling node based on measurements by the distributed units of the terminal device uplink signal or measurements taken by the terminal device and reported to the controlling node via one or more distributed units.

In the example of FIG. 2, two communication cells 20, 21 and one terminal device 40 are shown for simplicity, but it will of course be appreciated that in practice the system may comprise a larger number of communication cells (each supported by a respective controlling node and plurality of distributed units) serving a larger number of terminal devices.

It will further be appreciated that FIG. 2 represents merely one example of a proposed architecture for a new RAT telecommunications system in which approaches in accordance with the principles described herein may be adopted, and the functionality disclosed herein may also be applied in respect of wireless telecommunications systems having different architectures.

Thus certain embodiments of the disclosure as discussed herein may be implemented in wireless telecommunication systems/networks according to various different architectures, such as the example architectures shown in FIGS. 1 and 2.

It will thus be appreciated the specific wireless telecommunications architecture in any given implementation is not of primary significance to the principles described herein. In this regard, certain embodiments of the disclosure may be described generally in the context of communications between network infrastructure equipment/access nodes and a terminal device, wherein the specific nature of the network infrastructure equipment/access node and the terminal device will depend on the network infrastructure for the implementation at hand. For example, in some scenarios the network infrastructure equipment/access node may comprise a base station, such as an LTE-type base station 11 as shown in FIG. 1 which is adapted to provide functionality in accordance with the principles described herein, and in other examples the network infrastructure equipment may comprise a control unit/controlling node 26, 28 and/or a TRP 22, 24 of the kind shown in FIG. 2 which is adapted to provide functionality in accordance with the principles described herein.

### Current RACH Procedures in LTE

In wireless telecommunications networks, such as LTE type networks, there are different Radio Resource Control (RRC) modes for terminal devices. For example, it is common to support an RRC idle mode (RRC_IDLE) and an RRC connected mode (RRC_CONNECTED). A terminal device in the idle mode may transition to connected mode, for example because it needs to transmit uplink data or respond to a paging request, by undertaking a random access procedure. The random access procedure involves the terminal device transmitting a preamble on a physical random access channel and so the procedure is commonly referred to as a RACH or PRACH procedure/process.

In addition to a terminal device deciding itself to initiate a random access procedure to connect to the network, it is also possible for the network, e.g. a base station, to instruct a terminal device in connected mode to initiate a random access procedure by transmitting to the terminal device an instruction to do so. Such an instruction is sometimes referred to as a PDCCH order (Physical Downlink Control Channel order), see, for example, Section 5.3.3.1.3 in ETSI TS 136 213 V13.0.0 (2016-01)/3GPP TS 36.212 version 13.0.0 Release 13 [7].

There are various scenarios in which a network triggered RACH procedure (PDCCH order) may arise. For example:
a terminal device may receive a PDCCH order to transmit on PRACH as part of a handover procedure;
a terminal device that is RRC connected to a base station but has not exchanged data with the base station for a relatively long time may receive a PDCCH order to cause the terminal device to transmit a PRACH preamble so that it can be re-synchronised to the network and allow the base station to correct timings for the terminal device;
a terminal device may receive a PDCCH order so that it can establish a different RRC configuration in the subsequent RACH procedure, this may apply, for example, for a narrowband IoT terminal device which is prevented from RRC reconfiguration in connected mode whereby sending the terminal device to idle mode through a PDCCH order allows the terminal device to be configured in the subsequent PRACH procedure, for example to configure the terminal device for a different coverage enhancement level (e.g. more or fewer repetitions).

For convenience, the term PDCCH order is used herein to refer to signalling transmitted by a base station to instruct a terminal device to initiate a PRACH procedure regardless of the cause. However, it will be appreciated such an instruction may in some cases be transmitted on other channels/in higher layers. For example, in respect of an intra-system handover procedure, what is referred to here as a PDCCH order may be an RRC Connection Reconfiguration instruction transmitted on a downlink shared channel/PDSCH.

When a PDCCH order is transmitted to a terminal device, the terminal device is assigned a PRACH preamble signature sequence to use for the subsequent PRACH procedure. This is different from a terminal device triggered PRACH procedure in which the terminal device selects a preamble from a predefined set and so could by coincidence select the same preamble as another terminal device performing a PRACH procedure at the same time, giving rise to potential contention. Consequently, for PRACH procedures initiated by a PDCCH order there is no contention with other terminal devices undertaking PRACH procedures at the same time because the PRACH preamble for the PDCCH ordered terminal device is scheduled by the network/base station.

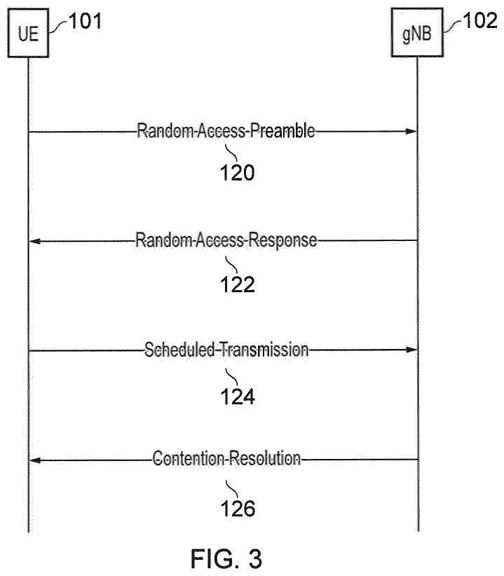

FIG. 3 shows a typical RACH procedure used in LTE systems such as that described by reference to FIG. 1 which could also be applied to an NR wireless communications system such as that described by reference to FIG. 2. A UE 101, which could be in an inactive or idle mode, may have some data which it needs to send to the network. To do so, it sends a random access preamble 120 to a gNodeB 102. This random access preamble 120 indicates the identity of the UE 101 to the gNodeB 102, such that the gNodeB 102 can address the UE 101 during later stages of the RACH procedure. Assuming the random access preamble 120 is successfully received by the gNodeB 102 (and if not, the UE 101 will simply re-transmit it with a higher power), the gNodeB 102 will transmit a random access response 122 message to the UE 101 based on the identity indicated in the received random access preamble 120. The random access response 122 message carries a further identity which is assigned by the gNodeB 102 to identify the UE 101, as well as a timing advance value (such that the UE 101 can change its timing to compensate for the round trip delay caused by its distance from the gNodeB 102) and grant uplink resources for the UE 101 to transmit the data in. Following the reception of the random access response message 122, the UE 101 transmits the scheduled transmission of data 124 to the gNodeB 102, using the identity assigned to it in the random access response message 122. Assuming there are no collisions with other UEs, which may occur if another UE and the UE 101 send the same random access preamble 120 to the gNodeB 102 at the same time and using the same frequency resources, the scheduled transmission of data 124 is successfully received by the gNodeB 102. The gNodeB 102 will respond to the scheduled transmission 124 with a contention resolution message 126.

In various 3GPP RAN2 meetings, some agreements have been achieved on assumptions for how UE states (e.g. RRC_IDLE, RRC_CONNECTED etc.) may translate to NR systems. In RAN2 #94, it was agreed that a new “inactive” state should be introduced, where the UE should be able to start data transfer with a low delay (as required by RAN requirements). At the time of RAN2 #94, an issue concerning how data transmissions would work when UEs are in the inactive state were unresolved; it was agreed that it was for further study whether data transfer should achieved by leaving the inactive state or whether data transfer should occur from within the inactive state.

In RAN2 #95, it was agreed that the possibility of the UE being able to transmit data in the inactive state without transition to connected state will be studied.

In RAN2 #95bis, two approaches were identified as follows, in addition to a baseline move to the connected state before the transmission of data:
Data could be transmitted together with an initial RRC message requesting a transition to the connected state, or
Data could be transmitted in a new state.

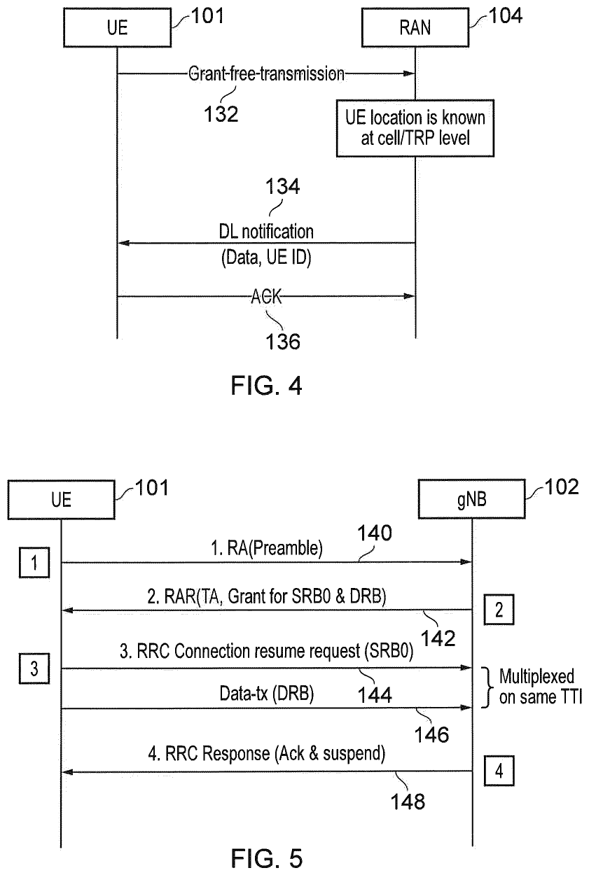

Discussions relating to uplink data transmission in the inactive state have sought solutions for sending uplink data without RRC signalling in the inactive state and without the UE initiating a transition to the connected state. A first potential solution is discussed in 3GPP document R2-168544 titled “UL data transmission in RRC_INACTIVE” (Huawei) [8]. This solution is shown in FIG. 4, which is reproduced along with the accompanying text from [8]. As shown in FIG. 4, an uplink data transmission 132 can be made to a network 104 in the RRC_INACTIVE state by a UE 101. The network 104 here at least knows in which cell the transmission 132 was received, and potentially may even know via which TRP. For a certain amount of time after receiving an uplink data packet, the network 104 could assume that the UE 101 is still in the same location, so that any RLC acknowledgement or application response could be scheduled for transmission to the UE 101 in the same area where the UE 101 is, for example in the next paging response 134. Alternatively, the UE 101 may be paged in a wider area. Following reception of this downlink response 134 the UE 101 may transmit an acknowledgement 136 to the network 104 to indicate that it was successfully received.

A second potential solution is discussed in 3GPP document R2-168713 titled “Baseline solution for small data transmission in RRC_INACTIVE” (Ericsson) [9]. This solution is shown in FIG. 5, which is reproduced along with the accompanying text from [9]. The mechanism described in FIG. 5 is for small data transmissions and is based on the Suspend-Resume mechanism for LTE. The main difference is that User Plane data is transmitted simultaneously with message 3 (the RRC Connection resume request 144 in FIG. 5) and an optional RRC suspend signalled in message 4. As shown in FIG. 5, initially under the assumption of a random access scheme as in LTE, when a UE 101 receives uplink data to transmit to a gNodeB 102 of a mobile communications network, the UE 101 first transmits a random access (RA) preamble 140. Here a special set of preambles (a preamble partition) can be used as in LTE to indicate a small data transmission (meaning that the UE 101 wants a larger grant and possibly that the UE 101 wishes to remain in the inactive state).

The network (via the gNodeB 102) responds with a random access response (RAR) message 142 containing timing advance and a grant. The grant for message 3 should be large enough to fit both the RRC request and a small amount of data. The allowable size of the data could be specified and linked to the preambles, e.g. preamble X asks for a grant to allow Y bytes of data. Depending on available resources, the gNodeB 102 may supply a grant for message 3 accommodating only the resume request, in which case an additional grant could be supplied after reception of message 3.

At this point the UE 101 will prepare the RRC Connection Resume Request 144 and perform the following actions:
Re-establish Packet Data Convergence Protocol (PDCP) for SRBs and all DRBs that are established;
Re-establish RLC for signalling radio bearers (SRBs) and all data radio bearers (DRBs) that are established. The PDCP should reset sequence numbers (SN) and hyper frame numbers (HFN) during this step;
Resume SRBs and all DRBs that are suspended;
Derive a new security key (e.g. eNB key, or KeNB) possible based on next-hop chaining counters (NCC) provided before the UE 101 was sent to the “inactive” state;
Generate encryption and integrity protection keys and configure PDCP layers with previously configured security algorithm;
Generate RRC Connection Resume Request message 144;
An indication, e.g. a buffer status report (BSR), of potentially remaining data is added;
An indication that the UE 101 wishes to remain in the inactive state (if this is not indicated by the preamble) is added;
Apply the default physical channel and media access control (MAC) configuration; and
Submit RRC Connection Resume Request 144 and data 146 to lower layers for transmission.

After these steps, the lower layers transmit Message 3. This can also contain User Plane data 146 multiplexed by MAC, like existing LTE specifications as security context is already activated to encrypt the User Plane. The signalling (using SRB) and data (using DRB will be multiplexed by MAC layer (meaning the data is not sent on the SRB).

The network (via the gNodeB 102) receives Message 3 and uses the context identifier to retrieve the UE's 101 RRC context and re-establish the PDCP and RLC for the SRBs and DRBs. The RRC context contains the encryption key and the User Plane data is decrypted (will be mapped to the DRB that is re-established or to an always available contention based channel).

Upon successful reception of Message 3 and User Plane data, the network (via the gNodeB 102) responds with a new RRC response message 148 which could either be an “RRC suspend” or an “RRC resume” or an “RRC reject”. This transmission resolves contention and acts as an acknowledgement of Message 3. In addition to RRC signalling the network can in the same transmission acknowledge any user data (RLC acknowledgements). Multiplexing of RRC signalling and User Plane acknowledgements will be handled by the MAC layer. If the UE 101 loses the contention then a new attempt is needed.
In case the network decides to resume the UE 101, the message will be similar to a RRC resume and may include additional RRC parameters.
In case the network decides to immediately suspend the UE 101, the message will be similar to a RRC suspend. This message can possibly be delayed to allow downlink acknowledgements to be transmitted.
In case the network sends a resume reject the UE 101 will initiate a new scheduling request (SR) as in LTE, after some potential backoff time.

This procedure will, strictly speaking, transmit the User Plane data without the UE 101 fully entering RRC_CONNECTED, which formerly would happen when the UE 101 receives the RRC Response (Message 4) indicating resume. On the other hand, it uses the RRC context to enable encryption etc. even if the network's decision is to make the UE 101 remain in RRC_INACTIVE by immediately suspending the UE 101 again.

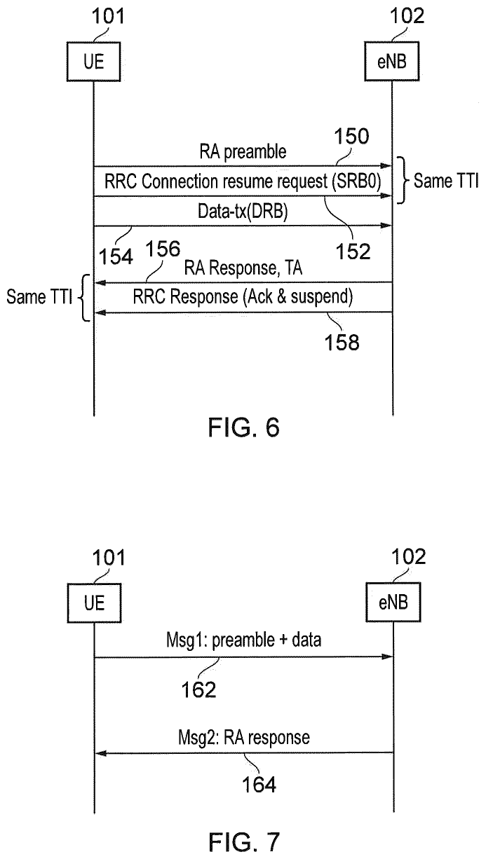

FIGS. 6 and 7 each show examples of a simplified two-step RACH procedure, in which small amounts of data can be transmitted by a UE 101 to an gNodeB or eNodeB 102. In the two-step RACH procedure, the data is transmitted at the same time as the RACH preamble (message 162 in FIG. 7), and so there is no need for the UE 101 to wait for a response from the network providing it with an uplink grant to transmit its data. However, the downside is that a limited amount of data can be transmitted in message 1. Following the reception of message 1 at the eNodeB 102, the eNodeB 101 transmits a random access response (message 162 in FIG. 7) to the UE 101, which comprises an acknowledgement of the received data in message 1. FIG. 6 shows the messages in a little more detail, where in message 1 (also termed herein msgA), the random access preamble 150, RRC connection resume request 152 and the small amount of data 154 are transmitted during the same transmission time interval (TTI). This message msgA is essentially a combination of Message 1 and Message 3 in the 4-step RACH procedure as shown for example in FIG. 5. Likewise, for message 2 (also termed herein msgB), the random access response with timing advance 156 and the RRC response 158 (comprising an acknowledgement and RRC suspend command) are transmitted by the eNodeB 102 to the UE 101 during the same TTI. This message msgB is essentially a combination of Message 2 and Message 4 in the 4-step RACH procedure as shown for example in FIG. 5. Further details relating to the two-step and four-step RACH procedures can be found in the 3GPP Technical Report 38.889 [10].

Embodiments of the present technique aim to provide a solution to optimise the four step RACH, for example the LTE RACH procedure shown in FIG. 3, and the two step RACH, such as that shown in FIGS. 6 and 7, in order to address medium to large data transmissions, where there is less delay and no requirement for communications devices to leave the inactive state.

### Optimisation of Uplink Data Transmission Message A in 2-Step RACH for 5G Systems

Embodiments of the present technique provide systems and methods which seek to optimise the resources of data transmission in msgA, as the UEs' locations or channel conditions within the cell are different. This means that the design and allocation of resources for data transmissions (PUSCH) should not be based on only a UE at the cell edge or a UE experiencing the worst channel conditions, probably for the largest cell size, as this would lead to inefficiencies in resource allocation for all UEs but those in the most remote locations in the biggest cells and experiencing the worst channel conditions. It is thus proposed by embodiments of the present disclosure that the resources for the transmission of data (i.e. the “message 3” portion of the new msgA in the two-step RACH process) to be adaptive based on how far UE is from the infrastructure equipment operating the cell, and/or on the UE's channel conditions.

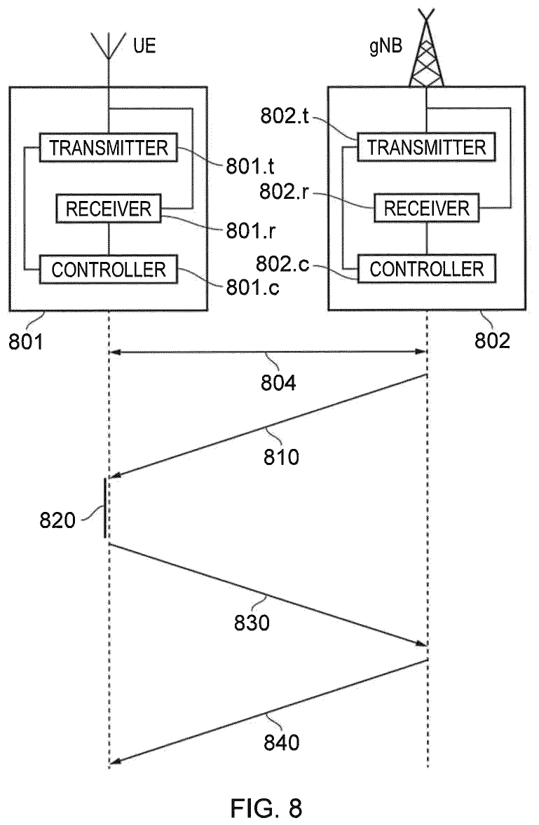

FIG. 8 provides a part schematic representation, part message flow diagram of communications between a communications device or UE 801 and an infrastructure equipment or gNodeB 802 of a wireless communications network in accordance with embodiments of the present technique. The infrastructure equipment 802 provides a cell having a coverage area within which the communications device 801 is located. The communications device 801 comprises a transmitter (or transmitter circuitry) 801.t configured to transmit signals to the infrastructure equipment 802 via a wireless access interface 804 provided by the wireless communications network, a receiver (or receiver circuitry) 801.r configured to receive signals from the infrastructure equipment 802 via the wireless access interface 804, and a controller (or controller circuitry) 801.c configured to control the transmitter circuitry 801.t and the receiver circuitry 801.r to transmit or to receive the signals. As can be seen in FIG. 8, the infrastructure equipment 802 also comprises a transmitter (or transmitter circuitry) 802.t configured to transmit signals to the communications device 801 via the wireless access interface 804, a receiver (or receiver circuitry) 802.r configured to receive signals from the communications device 801 via the wireless access interface 804, and a controller (or controller circuitry) 802.c configured to control the transmitter circuitry 802.t and the receiver circuitry 802.r to transmit or to receive the signals representing data. Each of the controllers 801.c, 802.c may be, for example, a microprocessor, a CPU, or a dedicated chipset, etc.

The controller circuitry 801.c of the communications device 801 is configured in combination with the receiver circuitry 801.r and the transmitter circuitry 801.t of the communications device 801 to receive an indication 810 of one or more communications parameters from the infrastructure equipment 802, the indication 810 of the one or more communications parameters comprising an indication of a plurality of reference signal received power, RSRP, thresholds, to determine 820, based on the received indication 810 of the one or more communications parameters, a location of the communications device 801 with respect to a location of the infrastructure equipment 802, to transmit a first signal 830 comprising a random access preamble and uplink data to the infrastructure equipment 802, the uplink data being transmitted in a set of communications resources of the wireless access interface, the random access preamble being associated with the set of communications resources, and to receive a random access response 840 from the infrastructure equipment 802. At least one of the random access preamble and a modulation and coding scheme, MCS, with which the first signal is transmitted 830 indicate the location of the communications device 801 with respect to the location of the infrastructure equipment 802.

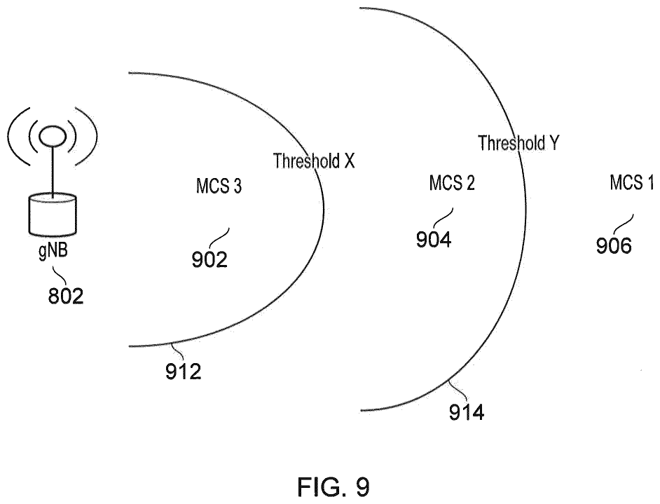

It is assumed that the size of the payload for message 3 is constant regardless of how far a UE is from the gNodeB, whether for example it is near to the cell center or to cell edge. However, the UE should be able to estimate the channel coding for message 3 in order to compensate for the channel propagation loss between the gNodeB and the UE. In order to estimate where the UE is located in the cell, the Reference Signal Received Power (RSRP) can be estimated from downlink transmitted reference signals from the gNodeB controlling the cell. For NR, RSRP is defined as the linear average over the power contributions (in MD of the resource elements that carry secondary synchronisation signals. As shown in FIG. 9, in some arrangements of embodiments of the present technique, a cell can be divided into multiple regions 902, 904, 906 based on RSRP thresholds 912, 914, where each region has a specific MCS scheme (modulation and coding scheme) intended for message 3 transmission in the uplink. In other words, each of the RSRP thresholds define one of a plurality of regions with respect to the location of the infrastructure equipment, a higher RSRP threshold defining a region closer to the location of the infrastructure equipment than a lower RSRP threshold. Each of the plurality of regions may be associated with one of a plurality of MCSs. These thresholds can be semi-statically signalled in SIB1 or can have fixed predefined values known to the UEs. The indication of the one or more communications parameters may comprise an indication of a plurality of MCSs. Although FIG. 9 illustrates three regions 902, 904, 906 divided by a first threshold X 912 and a second threshold Y 914, those skilled in the art would appreciate that any number of regions and/or thresholds could be equally applied to embodiments of the present technique.

It is also assumed that there is at least a one-to-one mapping between PRACH preambles and time-frequency resources of a PUSCH carrying the data part of msgA (i.e. one preamble corresponds to one specific set of PUSCH resources including code-domain PUSCH resources). In other words, the set of communications resources is one of a plurality of sets of communications resources of the wireless access interface, each of the plurality of sets of communications resources being associated with a unique random access preamble.

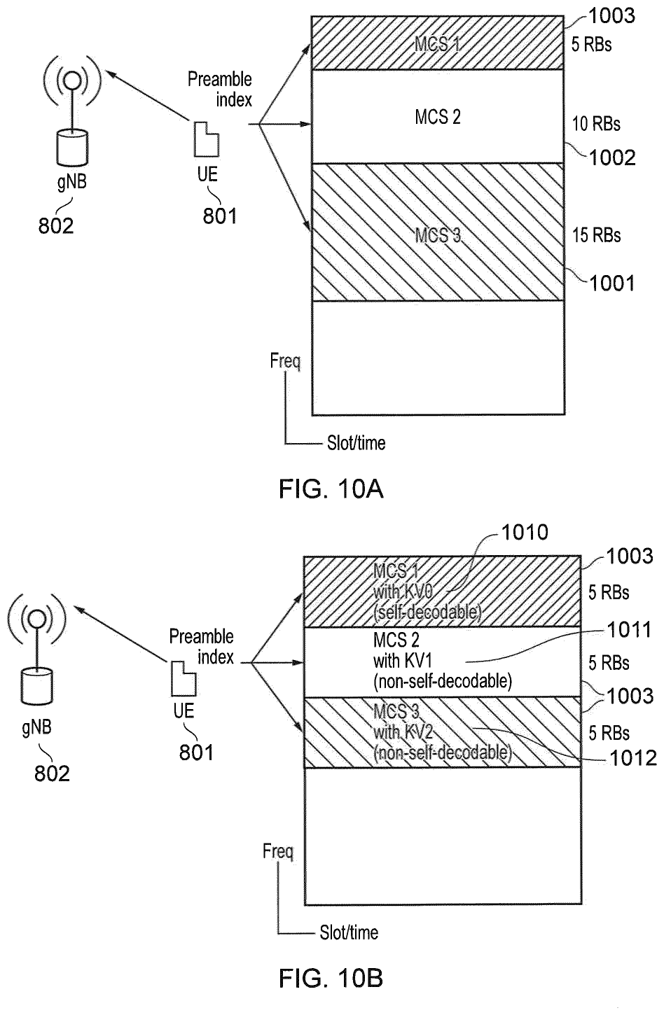

During initial access, the UE estimates the downlink RSRP and compares this against predefined thresholds to determine which region the UE is located in. Based on what that region is, in relation to how near or far from the gNodeB it is, the UE transmits a selected PRACH preamble as well as a corresponding MCS level for message 3 transmission, for example as shown in the example illustrated by FIG. 10A. In this example, if the UE 801 is located near the gNodeB 802, it applies MCS3 (coding rate=2/3 1003, if it is in the cell centre (i.e. a moderate distance from the gNodeB 802) it uses MCS2 (coding rate=1/2) 1002, and if it is at the cell edge it employs MCS1 (coding rate=1/3) 1001. The difference between these MCS levels is just the coding rate, as the payload is the same regardless of the UE's location in the cell. However, due to different MCS schemes (i.e. coding rates), the actual physical resources (i.e. number of PRBs) required and used for message 3 would also be different. In other words, the set of communications resources used by the communications device for the transmission of the uplink data of the first signal is dependent on the MCS, the MCS being one of a plurality of MCSs. One example of this is that a number of physical resource blocks, PRBs, is different for each of the plurality of sets of communications resources.

Another alternative, according to an arrangement of embodiments of the present technique, is to make the actual physical resources (i.e. number of PRBs) constant, but create multiple redundancy versions, where the first version contains all the information bits and some limited number of parity bits, while additional redundancy versions with more parity bits can be provided depending on the UE's location within the cell based on RSRP measurements. In other words, each of the plurality of sets of communications resources are associated with one or more of a plurality of Hybrid Automatic Repeat Request, HARQ, Redundancy Versions, RVs, the one or more of the plurality of HARQ RVs being used by the communications device in combination with the MCS to transmit the uplink data of the first signal in the set of communications resources. For example, as shown in FIG. 10B, if the UE 801 is located near the gNodeB 802 it applies only MCS3 1003 with RV0 1010, if it is in the cell centre it transmits MCS3 1003 with RV0 1010 and RV1 1011 at the same time, and if it is at the cell edge it employs MCS3 1003 with multiple redundancy versions of RV0 1010, RV1 1011 and RV2 1012. In addition, it should also be possible to have a single MCS scheme that is signalled in the SIB (or otherwise, via a broadcast, for example) to be used in the whole cell where different cell sizes can have a different MCS schemes. In other words, the indication of the one or more communications parameters comprises an indication of the MCS with which the first signal is transmitted by the communications device, the MCS being selected from among a plurality of MCSs based on a size of the cell provided by the infrastructure equipment.

msgA will be the first transmission from a UE to the gNodeB as part of the two-step RACH procedure, at a point when the UE does not have an active connection with the gNodeB, and so it is important that the gNodeB knows in which region the UE is located (or its current channel conditions) when receiving the PRACH preamble as well as message 3 (the uplink data portion of the first signal, i.e. msgA). In this case, the gNodeB could use one or more of the following methods to detect message 3 (i.e. the uplink data portion of the first signal):

Method 1: In some arrangements of embodiments of the present technique, the gNodeB may blindly decode message 3 from all possible resources. In other words, the receiving the first signal comprises the infrastructure equipment being configured to blindly decode each of a plurality of sets of communications resources in order to successfully receive the uplink data of the first signal. In a first option, as described above, where different MCS levels are employed, the UE first tries to decode the MCS3 resources, and if it is not successful, it tries the MCS2 resources, and finally if it is not successful it tries the MCS1 resources. In a second option, as described above, where different redundancy versions are used, the gNodeB tries to decode the MCS3 resources with RV0, and if it is not successful, it combines (aka. soft-combining for HARQ retransmissions) the MCS3 resources with RV1, and finally if it is not successful it combines the MCS3 resources with RV2. This method is more complex than other methods described below, as the gNodeB tries to prepare and decode multiple messages.

Method 2: In some arrangements of embodiments of the present technique, different preambles can be allocated for different regions of the cell based RSRP measurements. In other words, the receiving the first signal comprises the infrastructure equipment being configured to determine the set of communications resources in which the uplink data of the first signal is transmitted by the communications device based on the received random access preamble, which is associated with one of the plurality of regions. For example, preambles 0-23 can be allocated for UEs near the gNodeB, preambles 24-47 for UEs near to the cell centre, and preambles 48-63 for cell edge UEs. This method is less complex (i.e. there is no need for the above described blind decoding MCS scheme) as the gNodeB already knows which preambles correspond to which regions within the cell. However, this method reduces the number of preambles used for initial access procedures in a given region of the cell, as the full set of preambles must be divided between the number of regions there are.

Method 3: In some arrangements of embodiments of the present technique, the infrastructure equipment may be configured to employ a timing advance derived from the received preamble. The timing advance (TA) determines how far the UE is from the gNodeB, or in other words, in which region the UE is located within the cell. In other words, the receiving the first signal comprises the infrastructure equipment being configured to determine a timing advance value based on the received random access preamble, to determine the location of the communications device based on the timing advance value, the location of the communications device being within one of the plurality of regions, and to determine the set of resources in which the uplink data of the first signal is transmitted by the communications device based on the region within which the infrastructure equipment determines the location of the communications device to be. For example, TA values 0-X can be applied for UEs near the gNodeB, TA values (X+1)-Y for UEs near to the cell centre, and TA values (Y+1)-Z for cell edge UEs. The gNodeB will derive the timing advance value from the received preamble and based on this value the gNodeB determines in which region the UE is located within the cell, and hence will decode the corresponding PUSCH with the MCS level associated with that region in which the UE is located. This method is less accurate than other methods, as the UE chooses the MCS level for message 3 based on RSRP measurement, while the gNodeB applies the MCS level based on timing advance value. Hence, it is possible that there could be a mismatch between the UE's and gNodeB's assumptions. However, such a method is less complex compared to Method 1 as described above, and it does not reduce the number of available preambles in a given region of the cell compared to Method 2.

Method 4: In some arrangements of embodiments of the present technique, the infrastructure equipment may be configured to create multiple PRACH occasions/regions in the frequency domain in a slot, where each occasion corresponds to a region in a cell. Each region of the cell can use all possible preambles, and hence this method does not reduce the number of preambles available within a cell. In other words, the receiving the first signal comprises the infrastructure equipment being configured to divide one or more time divided slots of the wireless access interface into a plurality of physical random access channel, PRACH, occasions in the frequency domain, each of the PRACH occasions being associated with one of the plurality of regions, to determine the region within which the communications device is located based on the PRACH occasion within which the first signal is received, and to determine the set of resources in which the uplink data of the first signal is transmitted by the communications device based on the region within which the infrastructure equipment determines the location of the communications device to be.

There could be a potential mismatch between required signal-to-noise ratio (SINR) and the selected MCS, because uplink interference is a factor of SINR in addition to the distance of the UE from the gNodeB (i.e. pathloss). To avoid the gap between expected SINR at the gNodeB and MCS transmitted by the UE, two solutions of fine tuning are described below. One of these is a network-based solution, as the UE does not have knowledge of the uplink interference at the gNodeB, and then the UE just follows the guidance given by the gNodeB. The other solution is a UE-based solution where the UE is provided with some knowledge of the uplink interference, and then calculates a compensation value based on this knowledge.

The network knows the uplink interference at the gNodeB and transmission power used by the gNodeB. In addition, the network can know the averaged block error rate at some level. Thus, the network has good knowledge in order to compensate for the error. One arrangement of embodiments of the present technique here, on the network side, is that the gNodeB monitors the uplink interference level, or some other information (e.g. pathloss, UE-gNodeB distance, SINR, etc.) and then adjusts the RSRP threshold for each MCS to compensate for this monitored interference or other information. In other words, the infrastructure equipment is configured to determine at least one communications characteristic of signals received by the infrastructure equipment, and to adjust values of the one or more communications parameters based on the at least one determined communications characteristic. In some examples, the at least one communications characteristic is an uplink interference level of the signals received by the infrastructure equipment. In some examples, the values of the one or more communications parameters adjusted by the infrastructure equipment are values of the plurality of RSRP thresholds. For example, when the uplink interference is high, the gNodeB configures higher RSRP thresholds (good signal quality) than normal for a defined MCS level. The benefit of this is that additional signalling is not required. However, the coverage area of a specific MCS could be changed.

Another arrangement of embodiments of the present technique here is that the gNodeB sends the signalling of a MCS offset in addition to (or instead of) the adjusted RSRP thresholds. In other words, the indication of the one or more communications parameters comprises an indication of a plurality of MCSs, and wherein the values of the one or more communications parameters adjusted by the infrastructure equipment are offset values of the plurality of MCSs. For example, when the uplink interference is high, the gNodeB configures a negative value of the MCS offset in order to select lower MCS values.

In another arrangement of embodiments of the present technique here, the gNodeB broadcasts its uplink interference level per RB (Resource block) or multiple of RBs (e.g. sub-band) which can be a quantized value of the interference power. Then, when the UE selects the MCS scheme for the uplink PUSCH transmission, it takes into account the gNodeB uplink interference level, for example as follows:

Total pathloss=DL Tx power at gNodeB(based on ss-PBCH-BlockPower)−DL RSRP

SINR=(initial Tx power at the UE−Total pathloss)/interferences and noise at gNodeB

Then, the UE maps SINR value to the channel quality indicator (CQI) or the MCS scheme that is used for uplink PUSCH transmissions. In other words, the communications device is configured to receive, via a broadcast from the infrastructure equipment, an indication of at least one communications characteristic of signals received by the infrastructure equipment, and to select the MCS with which the first signal is transmitted by the communications device from among a plurality of MCSs based at least in part on the indication of the at least one communications characteristic. In some examples, the at least one communications characteristic is an uplink interference level of the signals received by the infrastructure equipment. The benefit of such a UE-based solution is that the UE can take the UE internal factors into account; for example, the SINR and MCS relation might not be perfectly linear because of RF/baseband design constraints. In addition, the UE may have other internal factors like buffer status (BSR), power headroom (PHR), etc. Another potential benefit in terms of system capacity is if the gNodeB broadcasts the uplink interference to UEs, this could be used for congestion control or capacity control. For example, when the interference level is higher than a given threshold, a UE which has a low priority logical channel is not allowed to send signals, or must reduce its transmission rate. The transmission restriction could be applicable for the application level of network slicing. For example, a mission critical application may have priority over non-mission critical application in cases of high interference.

In the above described UE-based solution, it is assumed that the MCS determination is based on initial Tx power at the UE (i.e. PREAMBLE_POWER_RAMPING_COUNTER=0), and the MCS level will not be changed during subsequent retransmissions of msgA with power ramping, i.e. power ramping is applied to both the preamble and the uplink data part if the first transmission has failed. However, it should be appreciated by those skilled in the art that it is also possible to re-evaluate the MCS level whenever the power level is ramped or incremented.

It should be appreciated by those skilled in the art that any information at or determined by the gNodeB described herein by way of description of the embodiments of the present technique, and arrangements, in relation to FIGS. 8, 9, 10A and 10B or otherwise, may be signalled to the UE in different ways. Such information includes the communications parameters (i.e. the RSRP thresholds, MCS levels, etc.) and the communications characteristics (e.g. uplink interference). The indication of the one or more communications parameters (or communications characteristics may be signalled directly by the infrastructure equipment to the plurality of communications devices. Alternatively, the indication of the one or more communications parameters (or communications characteristics) may be broadcast by the infrastructure equipment to be receivable by the plurality of communications devices. The values of the one or more communications parameters (or communications characteristics) may be signalled in at least one system information block. Alternatively, the values of the one or more communications parameters (or communications characteristics) may be fixed and predefined (for example they may form some sort of table known by or transmitted to the UE).

### Flow Diagram Representation

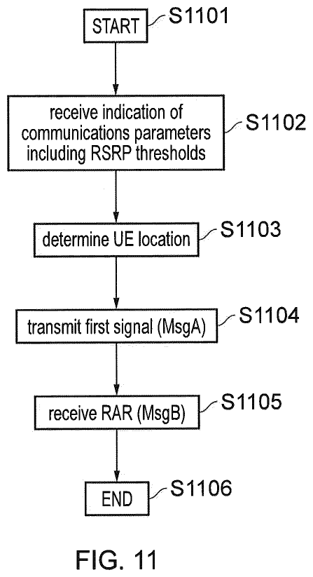

FIG. 11 shows a flow diagram illustrating method of operating a communications device for transmitting data to an infrastructure equipment of a wireless communications network, the infrastructure equipment providing a cell having a coverage area in which the communications device is located. The method begins in step S1101. The method comprises, in step S1102, receiving, via a wireless access interface provided by the wireless communications network, an indication of one or more communications parameters from the infrastructure equipment, the indication of the one or more communications parameters comprising an indication of a plurality of reference signal received power, RSRP, thresholds. The method then comprises in step S1103, determining, based on the received indication of the one or more communications parameters, a location of the communications device with respect to a location of the infrastructure equipment. In step S1104, the process comprises transmitting, via the wireless access interface, a first signal comprising a random access preamble and uplink data to the infrastructure equipment, the uplink data being transmitted in a set of communications resources of the wireless access interface, the random access preamble being associated with the set of communications resources. The process comprises, in step S1105, receiving a random access response from the infrastructure equipment. In such a method, at least one of the random access preamble and a modulation and coding scheme, MCS, with which the first signal is transmitted indicate the location of the communications device with respect to the location of the infrastructure equipment. The process ends in step S1106.

Those skilled in the art would appreciate that the method shown by FIG. 11 may be adapted in accordance with embodiments of the present technique. For example, other intermediate steps may be included in the method, or the steps may be performed in any logical order.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A communications device for transmitting data to an infrastructure equipment of a wireless communications network, the infrastructure equipment providing a cell having a coverage area in which the communications device is located, the communications device comprising
transmitter circuitry configured to transmit signals to the infrastructure equipment via a wireless access interface provided by the wireless communications network,
receiver circuitry configured to receive signals from the infrastructure equipment via the wireless access interface, and
controller circuitry configured in combination with the receiver circuitry and the transmitter circuitry
to receive an indication of one or more communications parameters from the infrastructure equipment, the indication of the one or more communications parameters comprising an indication of a plurality of reference signal received power, RSRP, thresholds,
to determine, based on the received indication of the one or more communications parameters, a location of the communications device with respect to a location of the infrastructure equipment,
to transmit a first signal comprising a random access preamble and uplink data to the infrastructure equipment, the uplink data being transmitted in a set of communications resources of the wireless access interface, the random access preamble being associated with the set of communications resources, and
to receive a random access response from the infrastructure equipment,
wherein at least one of the random access preamble and a modulation and coding scheme, MCS, with which the first signal is transmitted indicate the location of the communications device with respect to the location of the infrastructure equipment.

Paragraph 2. A communications device according to Paragraph 1, wherein the set of communications resources is one of a plurality of sets of communications resources of the wireless access interface, each of the plurality of sets of communications resources being associated with a unique random access preamble.

Paragraph 3. A communications device according to Paragraph 2, wherein the set of communications resources used by the communications device for the transmission of the uplink data of the first signal is dependent on the MCS, the MCS being one of a plurality of MCSs.

Paragraph 4. A communications device according to Paragraph 2 or Paragraph 3, wherein a number of physical resource blocks, PRBs, is different for each of the plurality of sets of communications resources.

Paragraph 5. A communications device according to any of Paragraphs 2 to 4, wherein each of the plurality of sets of communications resources are associated with one or more of a plurality of Hybrid Automatic Repeat Request, HARQ, Redundancy Versions, RVs, the one or more of the plurality of HARQ RVs being used by the communications device in combination with the MCS to transmit the uplink data of the first signal in the set of communications resources.

Paragraph 6. A communications device according to any of Paragraphs 1 to 5, wherein each of the RSRP thresholds define one of a plurality of regions with respect to the location of the infrastructure equipment, a higher RSRP threshold defining a region closer to the location of the infrastructure equipment than a lower RSRP threshold.

Paragraph 7. A communications device according to Paragraph 6, wherein each of the plurality of regions is associated with one of a plurality of MCSs.

Paragraph 8. A communications device according to any of Paragraphs 1 to 7, wherein the indication of the one or more communications parameters comprises an indication of a plurality of MCSs.

Paragraph 9. A communications device according to any of Paragraphs 1 to 8, wherein the indication of the one or more communications parameters comprises an indication of the MCS with which the first signal is transmitted by the communications device, the MCS being selected from among a plurality of MCSs based on a size of the cell provided by the infrastructure equipment.

Paragraph 10. A communications device according to any of Paragraphs 1 to 9, wherein the communications device is configured
to receive, via a broadcast from the infrastructure equipment, an indication of at least one communications characteristic of signals received by the infrastructure equipment, and
to select the MCS with which the first signal is transmitted by the communications device from among a plurality of MCSs based at least in part on the indication of the at least one communications characteristic.

Paragraph 11. A communications device according to Paragraph 10, wherein the at least one communications characteristic is an uplink interference level of the signals received by the infrastructure equipment.

Paragraph 12. A communications device according to any of Paragraphs 1 to 11, wherein the indication of the one or more communications parameters is received by the communications device via direct signalling from the infrastructure equipment.

Paragraph 13. A communications device according to any of Paragraphs 1 to 12, wherein the indication of the one or more communications parameters is received by the communications device via a broadcast from the infrastructure equipment.

Paragraph 14. A communications device according to any of Paragraphs 1 to 13, wherein values of the one or more communications parameters are signalled in at least one system information block.

Paragraph 15. A communications device according to any of Paragraphs 1 to 14, wherein values of the one or more communications parameters are fixed and predefined.

Paragraph 16. A method of operating a communications device for transmitting data to an infrastructure equipment of a wireless communications network, the infrastructure equipment providing a cell having a coverage area in which the communications device is located, the method comprising
receiving, via a wireless access interface provided by the wireless communications network, an indication of one or more communications parameters from the infrastructure equipment, the indication of the one or more communications parameters comprising an indication of a plurality of reference signal received power, RSRP, thresholds,
determining, based on the received indication of the one or more communications parameters, a location of the communications device with respect to a location of the infrastructure equipment,
transmitting, via the wireless access interface, a first signal comprising a random access preamble and uplink data to the infrastructure equipment, the uplink data being transmitted in a set of communications resources of the wireless access interface, the random access preamble being associated with the set of communications resources, and
receiving a random access response from the infrastructure equipment,
wherein at least one of the random access preamble and a modulation and coding scheme, MCS, with which the first signal is transmitted indicate the location of the communications device with respect to the location of the infrastructure equipment.

Paragraph 17. Circuitry for a communications device for transmitting data to an infrastructure equipment of a wireless communications network, the infrastructure equipment providing a cell having a coverage area in which the communications device is located, the communications device comprising
transmitter circuitry configured to transmit signals to the infrastructure equipment via a wireless access interface provided by the wireless communications network,
receiver circuitry configured to receive signals from the infrastructure equipment via the wireless access interface, and
controller circuitry configured in combination with the receiver circuitry and the transmitter circuitry
to receive an indication of one or more communications parameters from the infrastructure equipment, the indication of the one or more communications parameters comprising an indication of a plurality of reference signal received power, RSRP, thresholds,
to determine, based on the received indication of the one or more communications parameters, a location of the communications device with respect to a location of the infrastructure equipment,
to transmit a first signal comprising a random access preamble and uplink data to the infrastructure equipment, the uplink data being transmitted in a set of communications resources of the wireless access interface, the random access preamble being associated with the set of communications resources, and
to receive a random access response from the infrastructure equipment,
wherein at least one of the random access preamble and a modulation and coding scheme, MCS, with which the first signal is transmitted indicate the location of the communications device with respect to the location of the infrastructure equipment.

Paragraph 18. An infrastructure equipment forming part of a wireless communications network for transmitting data to or receiving data from a plurality of communications devices, the infrastructure equipment providing a cell having a coverage area in which the plurality of communications devices are located, the infrastructure equipment comprising
transmitter circuitry configured to transmit signals to the communications devices via a wireless access interface provided by the wireless communications network,
receiver circuitry configured to receive signals from the communications devices via the wireless access interface, and
controller circuitry configured in combination with the receiver circuitry and the transmitter circuitry
to transmit an indication of one or more communications parameters to the plurality of communications devices, the indication of the one or more communications parameters comprising an indication of a plurality of reference signal received power, RSRP, thresholds,
to receive a first signal comprising a random access preamble and uplink data from one of the communications devices, the uplink data being received in a set of communications resources of the wireless access interface, the random access preamble being associated with the set of communications resources, and
to transmit a random access response message to the one of the communications devices,
wherein at least one of the random access preamble and a modulation and coding scheme, MCS, with which the first signal is received indicate a location of the one of the communications devices with respect to a location of the infrastructure equipment.

Paragraph 19. An infrastructure equipment according to Paragraph 18, wherein the set of communications resources is one of a plurality of sets of communications resources of the wireless access interface, each of the plurality of sets of communications resources being associated with a unique random access preamble.

Paragraph 20. An infrastructure equipment according to Paragraph 19, wherein the set of communications resources used by the communications device for the transmission of the uplink data of the first signal is dependent on the MCS, the MCS being one of a plurality of MCSs.

Paragraph 21. An infrastructure equipment according to Paragraph 19 or Paragraph 20, wherein a number of physical resource blocks, PRBs, is different for each of the plurality of sets of communications resources.

Paragraph 22. An infrastructure equipment according to any of Paragraphs 19 to 21, wherein each of the plurality of sets of communications resources are associated with one or more of a plurality of Hybrid Automatic Repeat Request, HARQ, Redundancy Versions, RVs, the one or more of the plurality of HARQ RVs being used by the communications device in combination with the MCS to transmit the uplink data of the first signal in the set of communications resources.

Paragraph 23. An infrastructure equipment according to any of Paragraphs 18 to 22, wherein each of the RSRP thresholds define one of a plurality of regions with respect to the location of the infrastructure equipment, a higher RSRP threshold defining a region closer to the location of the infrastructure equipment than a lower RSRP threshold.

Paragraph 24. An infrastructure equipment according to Paragraph 23, wherein each of the plurality of regions is associated with one of a plurality of MCSs.

Paragraph 25. An infrastructure equipment according to any of Paragraphs 18 to 24, wherein the indication of the one or more communications parameters comprises an indication of a plurality of MCSs.

Paragraph 26. An infrastructure equipment according to any of Paragraphs 18 to 25, wherein the indication of the one or more communications parameters comprises an indication of the MCS with which the first signal is transmitted by the communications device, the MCS being selected from among a plurality of MCSs based on a size of the cell provided by the infrastructure equipment.

Paragraph 27. An infrastructure equipment according to any of Paragraphs 18 to 26, wherein the receiving the first signal comprises the infrastructure equipment being configured to blindly decode each of a plurality of sets of communications resources in order to successfully receive the uplink data of the first signal.

Paragraph 28. An infrastructure equipment according to any of Paragraphs 19 to 27, wherein the receiving the first signal comprises the infrastructure equipment being configured to determine the set of communications resources in which the uplink data of the first signal is transmitted by the communications device based on the received random access preamble.

Paragraph 29. An infrastructure equipment according to any of Paragraphs 23 to 28, wherein the receiving the first signal comprises the infrastructure equipment being configured
to determine a timing advance value based on the received random access preamble,
to determine the location of the communications device based on the timing advance value, the location of the communications device being within one of the plurality of regions, and
to determine the set of resources in which the uplink data of the first signal is transmitted by the communications device based on the region within which the infrastructure equipment determines the location of the communications device to be.

Paragraph 30. An infrastructure equipment according to any of Paragraphs 23 to 29, wherein the receiving the first signal comprises the infrastructure equipment being configured
to divide one or more time divided slots of the wireless access interface into a plurality of physical random access channel, PRACH, occasions in the frequency domain, each of the PRACH occasions being associated with one of the plurality of regions,
to determine the region within which the communications device is located based on the PRACH occasion within which the first signal is received, and
to determine the set of resources in which the uplink data of the first signal is transmitted by the communications device based on the region within which the infrastructure equipment determines the location of the communications device to be.

Paragraph 31. An infrastructure equipment according to any of Paragraphs 18 to 30, wherein the infrastructure equipment is configured
to determine at least one communications characteristic of signals received by the infrastructure equipment, and
to adjust values of the one or more communications parameters based on the at least one determined communications characteristic.

Paragraph 32. An infrastructure equipment according to Paragraph 31, wherein the at least one communications characteristic is an uplink interference level of the signals received by the infrastructure equipment.

Paragraph 33. An infrastructure equipment according to Paragraph 31 or Paragraph 32, wherein the values of the one or more communications parameters adjusted by the infrastructure equipment are values of the plurality of RSRP thresholds.

Paragraph 34. An infrastructure equipment according to any of Paragraphs 31 to 33, wherein the indication of the one or more communications parameters comprises an indication of a plurality of MCSs, and wherein the values of the one or more communications parameters adjusted by the infrastructure equipment are offset values of the plurality of MCSs.

Paragraph 35. An infrastructure equipment according to any of Paragraphs 18 to 34, wherein the indication of the one or more communications parameters is signalled directly by the infrastructure equipment to the plurality of communications devices.

Paragraph 36. An infrastructure equipment according to any of Paragraphs 18 to 35, wherein the indication of the one or more communications parameters is broadcast by the infrastructure equipment to be receivable by the plurality of communications devices.

Paragraph 37. An infrastructure equipment according to any of Paragraphs 18 to 36, wherein values of the one or more communications parameters are signalled in at least one system information block.

Paragraph 38. An infrastructure equipment according to any of Paragraphs 18 to 37, wherein values of the one or more communications parameters are fixed and predefined.

Paragraph 39. A method of operating an infrastructure equipment forming part of a wireless communications network for transmitting data to or receiving data from a plurality of communications devices, the infrastructure equipment providing a cell having a coverage area in which the plurality of communications devices are located, the method comprising
transmitting, via a wireless access interface provided by the wireless communications network, an indication of one or more communications parameters to the plurality of communications devices, the indication of the one or more communications parameters comprising an indication of a plurality of reference signal received power, RSRP, thresholds,
receiving, via the wireless access interface, a first signal comprising a random access preamble and uplink data from one of the communications devices, the uplink data being received in a set of communications resources of the wireless access interface, the random access preamble being associated with the set of communications resources, and
transmitting, via the wireless access interface, a random access response message to the one of the communications devices,
wherein at least one of the random access preamble and a modulation and coding scheme, MCS, with which the first signal is received indicate a location of the one of the communications devices with respect to a location of the infrastructure equipment.

Paragraph 40. Circuitry for an infrastructure equipment forming part of a wireless communications network for transmitting data to or receiving data from a plurality of communications devices, the infrastructure equipment providing a cell having a coverage area in which the plurality of communications devices are located, the infrastructure equipment comprising
transmitter circuitry configured to transmit signals to the communications devices via a wireless access interface provided by the wireless communications network,
receiver circuitry configured to receive signals from the communications devices via the wireless access interface, and
controller circuitry configured in combination with the receiver circuitry and the transmitter circuitry
to transmit an indication of one or more communications parameters to the plurality of communications devices, the indication of the one or more communications parameters comprising an indication of a plurality of reference signal received power, RSRP, thresholds,
to receive a first signal comprising a random access preamble and uplink data from one of the communications devices, the uplink data being received in a set of communications resources of the wireless access interface, the random access preamble being associated with the set of communications resources, and
to transmit a random access response message to the one of the communications devices, wherein at least one of the random access preamble and a modulation and coding scheme, MCS, with which the first signal is received indicate a location of the one of the communications devices with respect to a location of the infrastructure equipment.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] RP-161464, “Revised WID for Further Enhanced MTC for LTE,” Ericsson, 3GPP TSG RAN Meeting #73, New Orleans, USA, September 19-22, 2016.
[2] RP-161901, “Revised work item proposal: Enhancements of NB-IoT”, Huawei, HiSilicon, 3GPP TSG RAN Meeting #73, New Orleans, USA, Sep. 19-22, 2016.
[3] RP-170732, “New WID on Even further enhanced MTC for LTE,” Ericsson, Qualcomm, 3GPP TSG RAN Meeting #75, Dubrovnik, Croatia, Mar. 6-9, 2017.
[4] RP-170852, “New WID on Further NB-IoT enhancements,” Huawei, HiSilicon, Neul, 3GPP TSG RAN Meeting #75, Dubrovnik, Croatia, Mar. 6-9, 2017.
[5] Holma H. and Toskala A, “LTE for UMTS OFDMA and SC-FDMA based radio access”, John Wiley and Sons, 2009.
[6] RP-172834, “Revised WID on New Radio Access Technology,” NTT DOCOMO, RAN #78.
[7] ETSI TS 136 213 V13.0.0 (2016-01)/3GPP TS 36.212 version 13.0.0 Release 13.
[8] R2-168544, “UL data transmission in RRC_INACTIVE,” Huawei, HiSilicon, RAN #96.
[9] R2-168713, “Baseline solution for small data transmission in RRC_INACTIVE,” Ericsson, Ran #96.
[10] TR 38.889, V16.0.0, “3^{rd} Generation Partnership Project; Technical Specification Group Radio Access Network; Study on NR-based Access to Unlicensed Spectrum; (Release 16),” 3GPP, December 2018.

1. A communications device for transmitting data to an infrastructure equipment of a wireless communications network, the infrastructure equipment providing a cell having a coverage area in which the communications device is located, the communications device comprising
transmitter circuitry configured to transmit signals to the infrastructure equipment via a wireless access interface provided by the wireless communications network,
receiver circuitry configured to receive signals from the infrastructure equipment via the wireless access interface, and
controller circuitry configured in combination with the receiver circuitry and the transmitter circuitry
to receive an indication of one or more communications parameters from the infrastructure equipment, the indication of the one or more communications parameters comprising an indication of a plurality of reference signal received power, RSRP, thresholds,
to determine, based on the received indication of the one or more communications parameters, a location of the communications device with respect to a location of the infrastructure equipment,
to transmit a first signal comprising a random access preamble and uplink data to the infrastructure equipment, the uplink data being transmitted in a set of communications resources of the wireless access interface, the random access preamble being associated with the set of communications resources, and
to receive a random access response from the infrastructure equipment,
wherein at least one of the random access preamble and a modulation and coding scheme, MCS, with which the first signal is transmitted indicate the location of the communications device with respect to the location of the infrastructure equipment.

2. A communications device according to claim 1, wherein the set of communications resources is one of a plurality of sets of communications resources of the wireless access interface, each of the plurality of sets of communications resources being associated with a unique random access preamble.

3. A communications device according to claim 2, wherein the set of communications resources used by the communications device for the transmission of the uplink data of the first signal is dependent on the MCS, the MCS being one of a plurality of MCSs.

4. A communications device according to claim 2, wherein a number of physical resource blocks, PRBs, is different for each of the plurality of sets of communications resources.

5. A communications device according to claim 2, wherein each of the plurality of sets of communications resources are associated with one or more of a plurality of Hybrid Automatic Repeat Request, HARQ, Redundancy Versions, RVs, the one or more of the plurality of HARQ RVs being used by the communications device in combination with the MCS to transmit the uplink data of the first signal in the set of communications resources.

6. A communications device according to claim 1, wherein each of the RSRP thresholds define one of a plurality of regions with respect to the location of the infrastructure equipment, a higher RSRP threshold defining a region closer to the location of the infrastructure equipment than a lower RSRP threshold.

7. A communications device according to claim 6, wherein each of the plurality of regions is associated with one of a plurality of MCSs.

8. A communications device according to claim 1, wherein the indication of the one or more communications parameters comprises an indication of a plurality of MCSs.

9. A communications device according to claim 1, wherein the indication of the one or more communications parameters comprises an indication of the MCS with which the first signal is transmitted by the communications device, the MCS being selected from among a plurality of MCSs based on a size of the cell provided by the infrastructure equipment.

10. A communications device according to claim 1, wherein the communications device is configured
to receive, via a broadcast from the infrastructure equipment, an indication of at least one communications characteristic of signals received by the infrastructure equipment, and
to select the MCS with which the first signal is transmitted by the communications device from among a plurality of MCSs based at least in part on the indication of the at least one communications characteristic.

11. A communications device according to claim 10, wherein the at least one communications characteristic is an uplink interference level of the signals received by the infrastructure equipment.

12. A communications device according to claim 1, wherein the indication of the one or more communications parameters is received by the communications device via direct signalling from the infrastructure equipment.

13. A communications device according to claim 1, wherein the indication of the one or more communications parameters is received by the communications device via a broadcast from the infrastructure equipment.

14. A communications device according to claim 1, wherein values of the one or more communications parameters are signalled in at least one system information block.

15. A communications device according to claim 1, wherein values of the one or more communications parameters are fixed and predefined.

16. A method of operating a communications device for transmitting data to an infrastructure equipment of a wireless communications network, the infrastructure equipment providing a cell having a coverage area in which the communications device is located, the method comprising
receiving, via a wireless access interface provided by the wireless communications network, an indication of one or more communications parameters from the infrastructure equipment, the indication of the one or more communications parameters comprising an indication of a plurality of reference signal received power, RSRP, thresholds,
determining, based on the received indication of the one or more communications parameters, a location of the communications device with respect to a location of the infrastructure equipment,
transmitting, via the wireless access interface, a first signal comprising a random access preamble and uplink data to the infrastructure equipment, the uplink data being transmitted in a set of communications resources of the wireless access interface, the random access preamble being associated with the set of communications resources, and
receiving a random access response from the infrastructure equipment,
wherein at least one of the random access preamble and a modulation and coding scheme, MCS, with which the first signal is transmitted indicate the location of the communications device with respect to the location of the infrastructure equipment.

17.-38. (canceled)

39. A method of operating an infrastructure equipment forming part of a wireless communications network for transmitting data to or receiving data from a plurality of communications devices, the infrastructure equipment providing a cell having a coverage area in which the plurality of communications devices are located, the method comprising
transmitting, via a wireless access interface provided by the wireless communications network, an indication of one or more communications parameters to the plurality of communications devices, the indication of the one or more communications parameters comprising an indication of a plurality of reference signal received power, RSRP, thresholds,
receiving, via the wireless access interface, a first signal comprising a random access preamble and uplink data from one of the communications devices, the uplink data being received in a set of communications resources of the wireless access interface, the random access preamble being associated with the set of communications resources, and
transmitting, via the wireless access interface, a random access response message to the one of the communications devices,
wherein at least one of the random access preamble and a modulation and coding scheme, MCS, with which the first signal is received indicate a location of the one of the communications devices with respect to a location of the infrastructure equipment.

40. (canceled)
